(19) United States
(12) Patent Application Publication
(10) Pub. No.: US 2006/0101986 A1
(43) Pub. Date: May 18, 2006

(54) MUSICAL INSTRUMENT SYSTEM WITH MIRROR CHANNELS

(76) Inventor: I-Hung Hsieh, Kao-Hsiung City (TW)

Correspondence Address: NORTH AMERICA INTELLECTUAL PROPERTY CORPORATION, P.O. BOX 506, MERRIFIELD, VA, 22116, US

(21) Appl. No.: 10/904,480

(22) Filed: Nov. 12, 2004

(51) Int. Cl. G10H 7/00

(52) U.S. Cl. 84/645

(57) ABSTRACT

A method of simultaneously playing more than 16 channels in a musical instrument digital interface (MIDI) file includes creating a first number of first channels, creating a second number of second channels, wherein each of the second channels is assigned to exactly one of the first channels, and simultaneously playing the second channels when the corresponding first channels are played.

### BACKGROUND

The present invention relates to musical instrument digital interface (MIDI) files, and more specifically, to a method for increasing the number of channels in a MIDI file.

The musical instrument digital interface (MIDI) file type is a popular way to create songs using a variety of instruments with digital instructions indicating the instruments to be used and the starting time and duration of each note in the song. The General MIDI standard was created to create a common file system that could be used by a variety of musical software applications and hardware devices. According to the standard, a MIDI file allows 16 instruments to play at a time, each instrument in its own channel. Typically, the 10^{th} channel is reserved as a drum channel. There are 128 available instruments in the MIDI standard, and these instruments can be combined as multiple timbres to create new and unique instruments.

Please refer to FIG. 1. FIG. 1 is a diagram illustrating the creation of instruments using multi-timbres according to the related art. Three timbres 20, 22, and 24 are combined to create a first instrument 40. This first instrument 40 is then stored in a first MIDI channel 50. Similarly, two timbres 26 and 28 create a second instrument 42, which is stored in a third MIDI channel 54. Likewise, three timbres 30, 32, and 34 create a third instrument 44, and one timbre 36 is used to create a 128^{th} instrument 46 that is stored in a 16^{th} channel 56. In the example, no instrument is currently using a second channel 52 of the MIDI file. For devices such as a computer, there is plenty of memory available for storing and playing MIDI files.

Please refer to FIG. 2. FIG. 2 is a diagram illustrating memory resources used when creating an instrument from multiple timbres. A first memory block 60 is initially used for storing a first timbre to be used for creating an instrument. When a second timbre is to be added to the instrument, the second timbre is stored in an additional memory block 62. Likewise, when a third timbre is to be added for creating an instrument out of three timbres, a third memory block 64 is used. Thus, three memory blocks 60, 62, and 64 are needed for creating the new instrument out of the three timbres. As can be seen, the traditional way for creating new instruments through the addition of multiple timbres requires more memory resources as the number of timbers per instrument is increased. This is not a big problem in computers or other devices that contain large amounts of memory. However, this can become a problem in other devices, such as mobile phones, which have only a smaller amount of available memory.

### SUMMARY OF INVENTION

It is therefore an objective of the claimed invention to provide a method and an apparatus of playing a musical instrument digital interface (MIDI) file in order to solve the above-mentioned problems. By this invention, more instruments in the musical instrument digital interface (MIDI) file can be simultaneously played without additional memory or additional channels.

According to the claimed invention, a method of playing a MIDI file includes creating a first number of first channels; creating a second number of second channels, each of the second channels is assigned to one of the first channels; and playing the second channels when the corresponding first channels are played.

According to the claimed invention, a method of playing a musical instrument digital interface (MIDI) file includes creating a first number of first channels, wherein a memory block of a predetermined size is allocated to each of the first channels, and creating a second number of second channels, wherein each of the second channels is assigned to one of the first channels and the memory block allocated to each first channel having a corresponding second channel is divided into a first partition and a second partition. Data of each first channel having a corresponding second channel are stored into the first partition of the memory block and data of each second channel are stored into the corresponding second partition of the allocated memory block. The method further includes playing the second channels when the corresponding first channels are played.

According to the claimed invention, a method of producing reverberation in a MIDI file includes creating a first number of first channels; for each of the first channels, creating a corresponding second channel; storing in each of the second channels a duplicate of the corresponding first channels delayed by a predetermined period of time; and simultaneously playing the second channels when the corresponding first channels are played.

According to the claimed invention, an apparatus for playing a musical instrument digital interface (MIDI) file includes a first number of first channels, wherein a memory block of a predetermined size is allocated to each of the first channels; and a second number of second channels, each of the second channels is assigned to one of the first channels and the memory block allocated to each first channel having a corresponding second channel is divided into a first partition and a second partition. Data of each first channel having a corresponding second channel are stored into the first partition of the memory block and data of each second channel are stored into the corresponding second partition of the allocated memory block. In this invention, the second channels are played when the corresponding first channels are played.

It is an advantage of the claimed invention that the first and second channel data are both stored in separate partitions of the memory block allocated for the first channel data for creating more available channels without increasing the memory requirements for storing channel data. The use of the second channels allows more than 16 channels to be played simultaneously, thereby increasing the flexibility of MIDI files without requiring more memory resources.

These and other objectives of the present invention will no doubt become obvious to those of ordinary skill in the art after reading the following detailed description of the preferred embodiment that is illustrated in the various figures and drawings.

### BRIEF DESCRIPTION OF DRAWINGS

FIG. 1 is a diagram illustrating the creation of instruments using multi-timbres according to the related art.

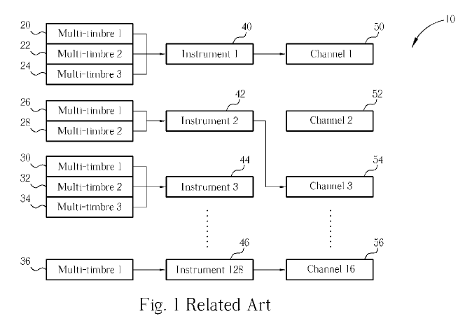

FIG. 2 is a diagram illustrating memory resources used when creating an instrument from multiple timbres.

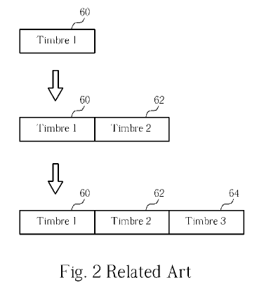

FIG. 3 is a diagram illustrating the use of mirror channels according to the present invention.

FIG. 4 is a diagram showing memory storage for regular and mirror channels according to the present invention.

FIG. 5 illustrates placing an instrument into both a regular channel and a mirror channel according to the present invention.

FIG. 6 shows how notes in mirror channels are delayed for creating a reverberation effect.

### DETAILED DESCRIPTION

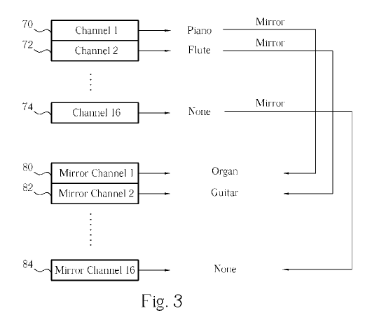

Please refer to FIG. 3. FIG. 3 is a diagram illustrating the use of mirror channels according to the present invention. As with the traditional MIDI standard, 16 regular MIDI channels are provided for playing 16 different instruments at a time. However, according to the present invention, up to 16 mirror channels are also provided, which allows up to 16 more instruments to be played simultaneously. As shown in FIG. 3, regular channels 70, 72, and 74 have corresponding mirror channels 80, 82, and 84. Both the regular channels and the mirror channels are used for playing different instruments. As an example, the regular channel 70 is used for playing the piano, the regular channel 72 is used for playing the flute, the mirror channel 80 is used for playing the organ, and the mirror channel 82 is used for playing the guitar.

Each mirror channel has a regular channel associated with it. One or more than one mirror channel can be associated with a particular regular channel. In a preferred embodiment of the present invention, there is a one-to-one mapping between the regular channels and the mirror channels, with the numbers of each type of channel being the same.

As shown in FIG. 3, regular channel 70 is associated with mirror channel 80, regular channel 72 is associated with mirror channel 82, and regular channel 74 is associated with mirror channel 84. When a regular channel is played in the MIDI file, any mirror channel associated with it will also be played at the same time.

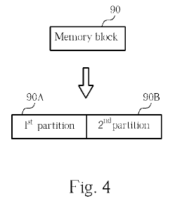

The present invention offers a way to add mirror channels to the existing regular channels without increasing the required memory. Please refer to FIG. 4. FIG. 4 is a diagram showing memory storage for regular and mirror channels according to the present invention. For each regular channel that is used in a MIDI file, the regular channel has an associated memory block 90 to store the regular channel data. Since the channel data typically takes up only a fraction of the available size of the memory block 90, the present invention provides a way to create mirror channels by efficiently utilizing the memory block. Here, when a corresponding mirror channel is created, the memory block is divided into a first partition 90A and a second partition 90B. The first partition 90A is used for storing the regular channel data and the second partition 90B is used for storing the mirror channel data. Since the regular channel data only takes up a fraction of the size of the memory block 90, partitioning the memory block 90 into the first and second partitions 90A and 90B allows the memory to be utilized efficiently. Thus, the same amount of memory that was previously used to store only the regular channel data can now be used to store both regular channel data and mirror channel data. This is especially important in devices with small memory sizes, such as mobile phones and personal digital assistants (PDAs).

One of the advantages of the present invention is that more than 16 unique instruments can be played at the same time through the use of the regular channels and the mirror channels. Although a regular channel and its corresponding mirror channel can be used for playing different instruments, they can also be used for playing the same instruments in order to create a reverberation effect. That is, the mirror channel is created as a duplicate of the corresponding regular channel, and each of the notes in the mirror channel is given a slight delay. When both the regular channel and the corresponding mirror channel are played together, the notes of the mirror channel are played shortly after the notes of the regular channel are played, thereby creating a reverberation effect.

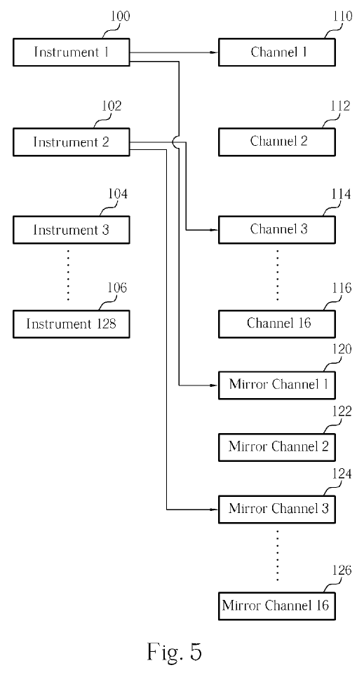

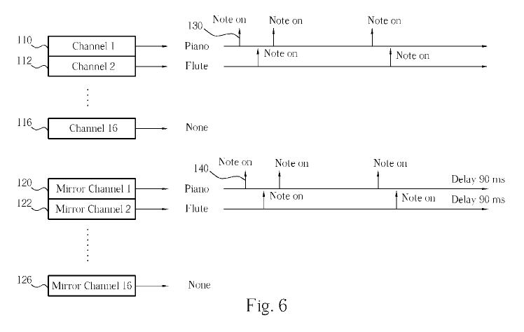

Please refer to FIG. 5 and FIG. 6. FIG. 5 illustrates placing an instrument into both a regular channel and a mirror channel according to the present invention. FIG. 6 shows how notes in mirror channels are delayed for creating a reverberation effect. A plurality of instruments 100, 102, 104, and 106 representing the available MIDI instruments are shown in FIG. 5. In addition a plurality of regular channels 110, 112, 114, and 116 and their corresponding mirror channels 120, 122, 124, and 126 are also shown. For understanding the reverberation creation according to the present invention, please take instrument 100 as an example. Instrument 100 is placed into regular channel 110 and mirror channel 120. As shown in FIG. 6, both regular channel 110 and mirror channel 120 contain music of the same instrument, namely a piano. To create a reverberation affect, each note of the mirror channel 120 is delayed by a predetermined period of time, which in this example is 90 ms. As can be seen from careful inspection of FIG. 6, note 140 of the mirror channel 120 is the same as note 130 of the regular channel 110, but with a slight delay. Therefore, the notes of the mirror channels 120 and 122 are slightly delayed duplicates of the notes of the corresponding regular channels 110 and 112.

In summary, the General MIDI standard states that there can be up to 16 channels in a MIDI file. When the present invention is used, more than 16 instruments and more than 16 channels can be used through the use of both regular channels and mirror channels. Assuming a one-to-one relation between regular channels and mirror channels, when more than eight regular channels and more than eight mirror channels are used in a MIDI file, the total number of channels is greater than 16. However, since the mirror channel data is stored in a different partition of the same memory block as the regular channel data, no extra memory is required to use the mirror channels of the present invention.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method of playing a musical instrument digital interface (MIDI) file, comprising:
creating a first number of first channels;
creating a second number of second channels, each of the second channels being assigned to one of the first channels; and
playing the second channels when the corresponding first channels are played.

2. The method of claim 1, wherein the second number is equal to the first number, and there is a one-to-one mapping between the first channels and the second channels.

3. The method of claim 1, wherein the first and second numbers are greater than 8.

4. The method of claim 1, wherein each pair of first and second channels contains data corresponding to different instruments.

5. The method of claim 1, wherein each pair of first and second channels contains data corresponding to the same instruments.

6. The method of claim 1, wherein the data of each of the second channels is a duplicate of the data of the corresponding first channels delayed by a predetermined period of time.

7. The method of claim 1, wherein a memory block of a predetermined size is allocated to each of the first channels, the memory block allocated to each first channel having a corresponding second channel is divided into a first partition and a second partition, wherein data of each first channel having a corresponding second channel are stored into the first partition of the memory block and data of each second channel are stored into the corresponding second partition of the allocated memory block.

8. A method of playing a musical instrument digital interface (MIDI) file, comprising:
creating a first number of first channels, wherein a memory block of a predetermined size is allocated to each of the first channels;
creating a second number of second channels, each of the second channels being assigned to one of the first channels, the memory block allocated to each first channel having a corresponding second channel being divided into a first partition and a second partition, wherein data of each first channel having a corresponding second channel are stored into the first partition of the memory block and data of each second channel are stored into the corresponding second partition of the allocated memory block; and
playing the second channels when the corresponding first channels are played.

9. The method of claim 8, further comprising storing data of each first channel that does not have a corresponding second channel into the allocated memory block.

10. The method of claim 8, wherein the second number is equal to the first number, and there is a one-to-one mapping between the first channels and the second channels.

11. The method of claim 8, wherein the first and second numbers are greater than 8.

12. The method of claim 8, wherein each pair of first and second channels contains data corresponding to different instruments.

13. The method of claim 8, wherein each pair of first and second channels contains data corresponding to the same instruments.

14. The method of claim 8, wherein the data of each of the second channels is a duplicate of the data of the corresponding first channels delayed by a predetermined period of time.

15. A method of producing reverberation in a musical instrument digital interface (MIDI) file, comprising:
creating a first number of first channels;
for each of the first channels, creating a corresponding second channel;
storing in each of the second channels a duplicate of the corresponding first channels delayed by a predetermined period of time; and
simultaneously playing the second channels when the corresponding first channels are played.

16. The method of claim 15, wherein the first number is greater than 8.

17. The method of claim 15, wherein each pair of first and second channels contains data corresponding to the same instruments.

18. An apparatus for playing a musical instrument digital interface (MIDI) file, comprising:
a first number of first channels, wherein a memory block of a predetermined size is allocated to each of the first channels; and
a second number of second channels, each of the second channels being assigned to one of the first channels, the memory block allocated to each first channel having a corresponding second channel being divided into a first partition and a second partition, wherein data of each first channel having a corresponding second channel are stored into the first partition of the memory block and data of each second channel are stored into the corresponding second partition of the allocated memory block;
wherein, the second channels are played when the corresponding first channels are played.

19. The apparatus of claim 18, wherein the second number is equal to the first number, and there is a one-to-one mapping between the first channels and the second channels.

20. The apparatus of claim 18, wherein the first and second numbers are greater than 8.

21. The apparatus of claim 18, wherein each pair of first and second channels contains data corresponding to different instruments.

22. The apparatus of claim 18, wherein each pair of first and second channels contains data corresponding to the same instruments.

23. The apparatus of claim 18, wherein the data of each of the second channels is a duplicate of the data of the corresponding first channels delayed by a predetermined period of time.

24. An apparatus for producing reverberation in a musical instrument digital interface (MIDI) file, comprising:
a plurality of first channels;
a plurality of second channels, each of the second channels having a one-to-one correspondence to each of the first channels, wherein each of the second channels stores a duplicate of the corresponding first channels delayed by a predetermined period of time; and
wherein, the second channels are played when the corresponding first channels are played.
